(19) United States
(12) Patent Application Publication
(10) Pub. No.: US 2024/0409813 A1
(43) Pub. Date: Dec. 12, 2024

(54) METHOD FOR OBTAINING AN ANTIOXIDANT COMPOSITION FROM LIGNIN, LIGNIN LIQUOR OR BLACK LIQUOR

(71) Applicant: FUNDACIÓN CENER, Sarriguren (ES)

(72) Inventors: Ibai FUNCIA MUGUERZA, Sarriguren (ES); Alberto CLEMENTE CORNAGO, Sarriguren (ES); Jon FERNÁNDEZ OCHOA, Sarriguren (ES)

(21) Appl. No.: 18/691,145

(22) PCT Filed: Sep. 13, 2022
(86) PCT No.: PCT/EP2022/075452

§ 371 Date: Mar. 12, 2024

(30) Foreign Application Priority Data
Sep. 13, 2021 (EP) 21382822.1

(51) Int. Cl. C09K 15/08; C07G 1/00

(52) U.S. Cl. CPC C09K 15/08; C07G 1/00

(57) ABSTRACT

The invention relates to a method for producing an antioxidant composition from lignin, lignin liquor or black liquor which comprises contacting the lignin, lignin liquor or black liquor with an oxidizing agent, wherein said contacting is carried out in alkaline conditions and at a temperature above 160° C., wherein when the oxidizing agent is oxygen, a gas mixture comprising oxygen or an oxygen-generating compound or composition, then the agent is added so that the oxygen partial pressure is below 0.3 MPa. The invention also relates to the antioxidant composition obtained by the method of the invention and to the uses thereof.

### FIELD OF THE INVENTION

The invention relates to a method for obtaining an antioxidant composition.

### BACKGROUND OF THE INVENTION

Organic matter has a strong tendency to react with oxygen and oxidize. This is true for most common organic materials, e.g., plastics, pesticides, cosmetics, elastomers, fibers, fuels, lubricants, silages, feeds and foods. Oxidation of organic materials takes place by a number of processes such as auto-oxidation, bio-oxidation, combustion and photo-oxidation, drastically affecting the product's properties and/or reducing its lifespan.

Antioxidants, inhibitors (of oxidation) or oxygen scavengers are organic or inorganic compounds that are added to oxidisable organic or biological materials to retard such oxidation, and in general to prolong the lifetime of the substrates. Naturally occurring antioxidants, mainly polyphenols, attract increasing attention because of their environmental compatibility and safety for the consumers. The antioxidant activities of polyphenols isolated from fruits, berries, vegetables, herbs, and grubs are preferably investigated. The by-products of the food industry and agriculture are also interesting in this context for economic and ecological reasons. At present, flavonoids, lignans, stilbenes, and phenolic acids are the best characterized antioxidants.

Lignin is an important constituent of the structural framework in plants forming part of the primary elements of the cell wall. Lignin is derived from numerous sources like pulp, wood and paper, sugarcane and cereal straws using variety of pulping methods. Physical, chemical and biochemical treatments are used for the extraction of lignin from other cellulosic materials.

Lignin is known to act as the stabilizers in that reaction which are induced by oxygen and its reactive species and also have the property to slow down the aging of biological systems and composites. The antioxidant property of lignin shows lots of potential applications in industry, healthcare and agriculture. Due to high thermal and biological activity, lignin could be used in place of those molecules which have lower molecular weight and also where the antioxidant activity of the single molecule is insufficient. However, this antioxidant activity depends greatly on lignocellulosic material from which lignin is obtained, the method used for its extraction, and the treatments applied during its isolation and purification. For the antioxidant activity of the lignin, free phenolic hydroxyl groups and ortho-methoxy substitution in aromatic rings are essential. But some compounds like the carbonyl group in the side chain shows a negative effect on the antioxidant activity of the lignin. Radical scavenging activity of lignin is decreased due to various factors which are important in functioning of lignin-like high molecular weight, polydispersity and heterogeneity.

In addition, lignin derivatives are known to have antioxidant properties (Pan X. et al. J. Agric. Food Chem., Vol. 54, No. 16, 2006, pp. 5806-5813) but, to date, these properties have been highly variable making difficult industrial application of lignin derivatives as an antioxidant. Depolymerization of lignin is a viable route for the preparation of low molecular weight products i.e., depolymerized lignins, with higher functionality/hydroxyl number and better reactivity. Classical depolymerization processes operate at high temperature-pressure (as high as 8-12 mPa) reactions conditions and said high temperature-pressure processes are associated with high capital/operating cost and more challenges in large-scale industrial applications.

Therefore, there is a need in the art of alternative methods for obtaining an antioxidant composition from lignin derivatives.

### SUMMARY OF THE INVENTION

In a first aspect, the invention relates to a method for producing an antioxidant composition from lignin or black liquor which comprises contacting the lignin, lignin liquor or black liquor with an oxidizing agent, wherein said contacting is carried out in alkaline conditions and at a temperature above 160° C., wherein when the oxidizing agent is oxygen, a gas mixture comprising oxygen or an oxygen-generating compound or composition, then the agent is added so that the oxygen partial pressure is below 0.3 MPa.

In another aspect, the invention relates to an antioxidant composition obtained by the method of the invention.

In another aspect, the invention relates to the use of the antioxidant composition according to the invention as an ingredient in a cosmetic, pharmaceutical, plastic, rubber, latex, fuel, lubricant or food formulations.

Another aspect of the invention relates to a cosmetic, pharmaceutical, plastic, rubber, latex, fuel, lubricant, food or feed formulation comprising the antioxidant composition of the invention.

### DESCRIPTION OF THE FIGURES

FIG. 1. Antioxidant activity (DPPH assay, in black) and phenolic content (TPC, in grey) of the obtained products from hardwood (H, left) and softwood (S, right) processed wastes. Starting materials such as kraft lignin (KL) and black liquor (BL) are shown for comparison for each wood origin. Results are expressed as antioxidant activity related to the same mass of commercial antioxidant BHT.

FIG. 2. Antioxidant activity (DPPH assay) of the obtained products from hardwood (H) and softwood(S) relative to the same mass of BHT, compared to other commercially available antioxidants from natural (Rosemary Extract and α-Tocopherol) or synthetic (Irganox 1010 and TBHQ) origin.

FIG. 3. Effect of reaction temperature on radical scavenging activity and product yield. RSA: Radical scavenging activity.

FIG. 4. Effect of reaction time (min) at 240° C. reaction temperature on re-lignification. Relig: Re-lignification, PD: Polydispersity.

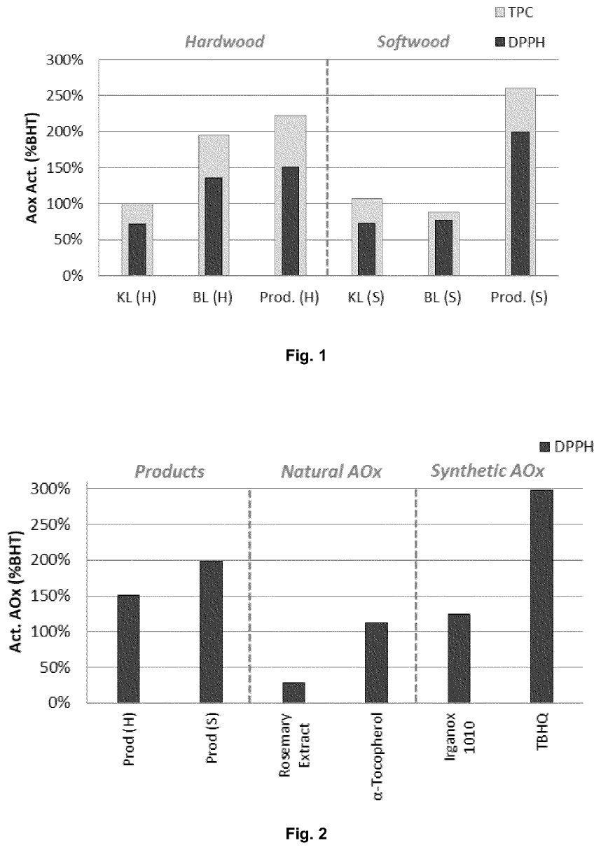

### DESCRIPTION OF THE INVENTION

The authors of the present invention have developed a process for obtaining an antioxidant composition from lignin, lignin liquor or black liquor said composition having high antioxidant activity. The method of the invention employs mild depolimerization conditions, which results in that certain parts of the lignin are activated by functionalization. This avoids the problems and disadvantages of the classical depolimerization process which are carried out at high temperature-pressure conditions, such as high capital/operating cost and more challenges in large-scale industrial applications. The method of the invention allows controlled fragmentation of lignin, lignin liquor or black liquor and at the same time a functionalization with enough OH groups per molecule, resulting in a product that shows high antioxidant activity.

### Method of the Invention

The present invention provides a method for producing an antioxidant composition from lignin or black liquor which comprises contacting the lignin, lignin liquor or black liquor with an oxidizing agent, wherein said contacting is carried out in alkaline conditions and at a temperature above 160° C., wherein when the oxidizing agent is oxygen, a gas mixture comprising oxygen or an oxygen-generating compound or composition, then the agent is added so that the oxygen partial pressure is below 0.3 MPa.

“Antioxidant composition”, as used herein relates to a composition which reduces the amount of oxidation over a given period when compared to the oxidation that would occur in the absence of that composition or it is a meant a material which increase the time required for a given amount of oxidation to occur when compared to the oxidation that would occur in the absence of that composition.

The antioxidant activity can be determined by means of any known assay such as DPPH (2,2-diphenyl-1-picrylhydrazyl) and ABTS tests. The antioxidant capacity can also be determined by measuring the ability of antioxidant compounds to react with a given free radical, or determining that such compounds would have potential to reduce the complex formed between Fe (III) ions and the reagent TPTZ (2, 4,6-tripyridyl-s-triazine). Among those tests that rely on measuring the ability of antioxidants to react with a free radical, ORAC test (Oxygen Radical Absorbance Capacity Oxygen Radical Absorbance Capacity), TEAC assay (Trolox Equivalent Antioxidant Capacity or as Trolox equivalent antioxidant capacity). In addition, the Radical Scavenging Index (RSI) a measure of radical scavenging capacity can be used for determining the antioxidant capacity. In a preferred embodiment, the antioxidant capacity is determined by DPPH method (RSA, Radical Scavenging Activity).

The first step of the method of the invention comprises contacting the lignin, lignin liquor or black liquor with an oxidizing agent.

“Lignin” as used herein relates to branched phenolic natural biopolymer primarily composed of three phenylpropanoid building units p-hydroxyphenylpropane, guaiacylpropane, and syringylpropane.

“Lignin liquor”, as used herein relates to the waste stream from the process of pre-treatment of lignocellulosic biomass in order to deconstruct biomass structure to remove sugar polymer fractions (mainly celluloses and or hemicelluloses) and other extractives from the starting material. Apart from lignin, the waste can contain soluble reactive and un-reactive soluble chemical substances and the degraded, dissolved lignocellulosic fractions.

“Technical lignin”, as used herein relates to the lignin recovered from lignin liquor by chemical of physical separation techniques such as acid precipitation, solvent extraction and or filtration based on fractionating by molecular weight to isolate lignin from other soluble substances present in the lignin liquor.

“Black liquor”, as used herein relates to the waste product from the kraft process when digesting pulpwood into paper pulp removing lignin, hemicelluloses and other extractives from the wood to free the cellulose fibers. It contains most of the original cooking inorganic elements and the degraded, dissolved wood substance. The latter includes acetic acid, formic acid, saccharinic acids, numerous other carboxylic acids (all as the sodium salts), dissolved hemicelluloses (especially xylans), methanol, and hundreds of other components.

In a preferred embodiment the starting material is a sulfur-containing lignin. Examples of sulfur-containing lignin are kraft lignin and lignosulfonates.

In a more preferred embodiment, the starting material is kraft lignin.

“Kraft lignin” as used herein relates to the main by-product of the Kraft pulping process which is the traditional method to obtain cellulose pulp from biomass using sodium hydroxide and sodium sulfide under strongly alkaline conditions, to cleave the bonds of the wood chemical components. This process produces a large amount of kraft lignin. During kraft cooking of wood, lignin is depolymerized because of the cleavage of aryl ether bonds and degraded into various fragments of different molecular weights, which become soluble in alkali solutions. After cooking, the alkali-dissolved lignin is acidified and concentrated for recovery. The recovered kraft lignin contains several characteristic features, which distinguishes it from native and other technical lignins. One of the main characteristics is the presence of high amounts of condensed chemical structures and the high level of phenolic hydroxyl groups, resulting from the extensive cleavage of β-aryl bonds during the cooking process. Kraft lignin contains sulfur in its chemical structure as a result of the sulphidation.

In another preferred embodiment, the starting material is lignosulfate lignin.

“Lignosulfonates”, as used herein relates to other class of sulfur-containing lignin obtained from the sulphite chemical pulping process, which is based on the cooking of wood with an aqueous solution of sulphur dioxide (SO₂) and a base (calcium, sodium, magnesium or ammonium). The lignosulfonates are highly cross-linked polymers with an approximately 5% sulphur content and is comprised of two types of ionizable groups: sulfonates (pKa≤2) and hydroxyl groups (pKa˜10). The lignosulfonates are quite soluble in water and alkali or basic solutions, as well as in highly polar organic solvents.

In a preferred embodiment the starting material is a sulfur-free lignin. Examples of sulfur-free lignin are organosolv lignin, soda lignin and klason lignin.

In another preferred embodiment, the starting material is organosolv lignin.

“Organosolv lignin”, is the common name for lignin obtained as a by-product of the fractionation of hardwood, softwood, and herbaceous crop residues, using solvents such as alcohols, organic acids, or mixtures of them. It shows interesting properties such as low molecular weight, narrow molecular weight distribution, poor solubility in water, and high phenolic and aliphatic hydroxyl contents.

In another preferred embodiment, the starting material is soda lignin.

“Soda lignin”, as used herein relates to the product obtained by treating lignocellulosic materials such as bagasse, sisal, wheat straw, hemp, or kenaf with highly alkaline solutions (typically sodium hydroxide) under conditions similar to kraft pulping, but without inclusion of hydrogen sulphide anions. In the soda pulping process, lignin extraction arises due to the hydrolytic cleavage of the native lignin network. Several steps, including acid precipitation, heating, and filtration are used to recover lignin by this process.

In another preferred embodiment, the starting material is klason lignin.

“Klason lignin”, as used herein relates to the residue obtained after total acid hydrolysis or autohydrolysis of the carbohydrate portion of wood.

In another preferred embodiment, the starting material is steam explosion lignin.

“Steam explosion lignin”, as used herein relates with lignin contained in or extracted from the waste derived from biomass pre-treatment by means of heating and saturated vapour. Biomass structure is deconstructed by sudden de-pressure in the final step. This process separates lignin and cellulose in solid form from hemicelluloses which remains soluble. Celluloses are converted into simple sugars by enzymatic hydrolysis for their valorisation while steam explosion lignin is recovered solid.

In another preferred embodiment, the starting material is black liquor.

“Black liquor”, as used herein relates to the waste product from the kraft process when digesting pulpwood into paper pulp removing lignin, hemicelluloses and other extractives from the wood to free the cellulose fibers. It is a complex colloidal system consisting of water, organic and inorganic sulphur compounds, inorganic sodium salts, primarily in the form of carbonates and sulphides, residual caustic soda, hemicellulose and lignin.

In a preferred embodiment the starting material is obtained from softwoods. Illustrative non-limitative examples of softwoods are pine or spruce. In a preferred embodiment, the starting material is obtained from pine, more particularly the starting material is black liquor from pine.

In another preferred embodiment, the starting material is obtained from hardwoods. Illustrative non-limitative examples of hardwoods are birch, poplar, eucalyptus, beech, oak, maple, cherry, ash, aspen, elm or acacia. In a more preferred embodiment, the starting material is obtained from eucalyptus.

In another preferred embodiment, the starting material is obtained from an herbaceous biomass such as switchgrass, miscanthus, corn stover cereal crops, pastures, oilseed crops, tubers and legumes, flowers, herbaceous biomass of gardens, parks, pruning, vineyards, orchards, or mixtures of all these.

“Oxidizing agent”, as used herein relates to a chemical species that undergoes a chemical reaction in which it gains one or more electrons, having ability to oxidize other substances. In a preferred embodiment, the oxidizing agent is selected from the group consisting of oxygen, a mix of gases comprising oxygen and an oxygen-generator compound or composition.

“Oxygen generator compound or composition” as used herein relates to a compound or composition that releases oxygen via a chemical reaction.

Illustrative non-limitative examples of oxygen-generator compounds are ozone, hydrogen peroxide, deionized water, O₂ plasma and alcohols. In a preferred embodiment, the mix of gases comprising oxygen is air.

In another preferred embodiment, the air is continuously fed into the reaction zone.

The contact of the lignin or black liquor with an oxidizing agent in the method of the invention is carried out in alkaline conditions and at a temperature above 160° C. and when the oxidizing agent is oxygen, a gas mixture comprising oxygen or an oxygen-generating compound or composition, then the agent is added so that the oxygen partial pressure is below 0.3 MPa.

The alkaline conditions and/or temperature above 160° C. is maintained during the whole residence time, during at least 95% of the residence time, at least 90%, at least 85%, at least 80%, at least 75%, at least 70%, at least 65%, at least 60%, at least 55% or at least 50% of the residence time.

“Alkaline conditions”, as used herein relates to a pH of greater than 10.

In a preferred embodiment, the alkaline conditions are achieved by an Arrhenius base.

“Arrhenius base”, as used herein relates to a compound that increases the OH-ion concentration in aqueous solution.

In a preferred embodiment, the Arrhenius base is selected from the group consisting of sodium hydroxide, sodium carbonate, potassium hydroxide, magnesium hydroxide, and calcium hydroxide. In a more preferred embodiment, the Arrhenius base is sodium hydroxide.

In a preferred embodiment, if the method comprises using oxygen at a temperature above about 200° C., at a pressure above about 6.895 MPa for a time not exceeding about 10 minutes and an alkaline condition using an alkaline metal substance, then the starting material is not black liquor.

“Alkaline metal substance” as used herein relates to alkali metal hydroxide, for example NaOH, KOH, LIOH.

Different concentrations of sodium hydroxide can be added in the medium contacting the lignin, lignin liquor or black liquor and the oxidizing agent. In a preferred embodiment, the concentration of sodium hydroxide is from 1 to 120 g/l. In another preferred embodiment, the concentration is from 2 to 100 g/l, more preferably from 5 to 95 g/l, more preferably from 10 to 95 g/l more preferably from 10 to 85 g/l, more preferably from 15 to 80 g/l, more preferably from 20 to 75 g/l, more preferably from 25 to 70 g/l, more preferably from 30 to 65 g/l, more preferably from 35 to 60 g/l, more preferably from 40 to 55 g/l.

In another preferred embodiment, the concentration of sodium hydroxide is 2-80 g/l.

In an embodiment, if the starting material is black liquor, not additional alkaline agent or Arrhenius base is added to obtain an alkaline condition in the method of the invention. In a particular embodiment, if the starting material is black liquor, said starting material contains sodium hydroxide in a concentration of about 2-4 g/l.

In a preferred embodiment, the residence time of the method of the invention is below 30 min, preferably 10-30 min, more preferably 10-25 min, more preferably 10-20 min, more preferably 10-15 min. In another preferred embodiment, the residence time is below 15 min, preferably below 14 min, more preferably below 13 min, more preferably below 13 min, more preferably below 12 min, more preferably below 11 min, more preferably below 10 min.

“Residence time”, as used herein relates to the average length of time during which the lignin, lignin liquor or black liquor is in contact with the oxidizing agent in alkaline conditions.

According to the invention, the contact of the lignin or black liquor with an oxidizing agent in alkaline condition can be carried out in different conditions of oxygen partial pressure, total pressure or pH.

In a preferred embodiment, the contact of the lignin, lignin liquor or black liquor and the oxidizing agent is carried out at an oxygen partial pressure of 0.05 to 0.5 MPa. In another preferred embodiment, the oxygen partial pressure is of 0.06 to 0.14 MPa, more preferably of 0.07 to 0.13 MPa, more preferably of 0.08 to 0.12 MPa, more preferably 0.09 to 0.2 MPa, more preferably 0.1 to 0.25 MPa, more preferably 0.15 to 0.3 MPa, more preferably 0.2 to 0.35 MPa, more preferably 0.25 to 0.4 MPa, more preferably 0.3 to 0.45 MPa, more preferably 0.35 to 0.5 MPa.

In a preferred embodiment, the contact of the lignin, lignin liquor or black liquor and the oxidizing agent is carried out at an oxygen partial pressure below 0.3 MPa. In another preferred embodiment, the oxygen partial pressure is 0.01-0.3 MPa. In another preferred embodiment, the oxygen partial pressure is of 0.05 to 0.3 MPa. In another preferred embodiment, the oxygen partial pressure is of 0.06 to 0.14 MPa, more preferably of 0.07 to 0.13 MPa, more preferably of 0.08 to 0.12 MPa, more preferably 0.09 to 0.2 MPa, more preferably 0.1 to 0.25 MPa, more preferably 0.15 to 0.3 MPa, more preferably 0.2 to 0.25 MPa, more preferably 0.25 to 0.3 MPa, more preferably 0.25 to 0.275 MPa.

In addition, in a preferred embodiment the contact of the lignin, lignin liquor or black liquor and the oxidizing agent is carried out in a total pressure of 2-5.5 MPa. In another preferred embodiment the total pressure is 2.5-5 MPa, more preferably 3-4.5 MPa, more preferably 3.5-4 MPa.

In another preferred embodiment, the contact of the lignin, lignin liquor or black liquor and the oxidizing agent is carried out at a pH above 10 and below 14. In a preferred embodiment, the pH is above 11.9, more preferably above 12, more preferably above 12.1, more preferably 12.2, more preferably 12.3, more preferably 12.4, more preferably 12.5, more preferably 12.6, more preferably 12.7, more preferably 12.8, more preferably 12.9, more preferably 13, more preferably 13.1, more preferably 13.2, more preferably 13.3, more preferably 13.4, more preferably 13.5, more preferably 13.6, more preferably 13.7, more preferably 13.8, more preferably 13.9.

The method of the invention requires that the contact of the starting material with the oxidizing agent is carried out at a temperature above 160° C. In a preferred embodiment, the temperature is about 160-260° C., preferably about 205-255° C., preferably 210-250° C., preferable 215-245° C., preferably 220-240° C., preferably 225-235° C. In another preferred embodiment, the temperature is 170° C., more preferably 175° C., more preferably 180° C., more preferably 185° C., more preferably 190° C., more preferably 195° C., more preferably 200° C., more preferably 205° C., more preferably 210° C., more preferably 215° C., more preferably 220° C., more preferably 225° C., more preferably 230° C., more preferably 235° C. In another preferred embodiment, the temperature is about 240° C. In another preferred embodiment, the temperature is below 250° C., more preferably below 245° C., more preferably below 240° C. In another preferred embodiment, wherein the starting material is lignin, the temperature is not 175° C. In another preferred embodiment, wherein the starting material is lignin the temperature is not 200° C. In another preferred embodiment, wherein the starting material is lignin the temperature is not 225° C.

Moreover, different concentrations of starting material can be used in the method of the invention. In a preferred embodiment, the kraft lignin as starting material is added at a concentration of 7-100 g/l. In a more preferred embodiment kraft lignin is added a concentration of 7-95 g/l, more preferably 10-95 g/l, more preferably 25-95 g/l, more preferably 30-90 g/l, more preferably 35-85 g/l, more preferably 40-80 g/l, more preferably 45-75 g/l, more preferably 50-70 g/l, more preferably 55-65 g/l.

The method of the invention can comprise further steps in order to recover and purify the antioxidant composition, such as separation, recovery from one of the separated phases and/or purification.

In a preferred embodiment, the method of the invention further comprises a step of fractionating the composition based on the molecular weight of the compounds forming part of the composition. In a preferred embodiment, the molecular weight cut-off of the fractionation is of at least 1000 Da. In another preferred embodiment, the molecular weight cut-off of the fractionation is of at least 1500 Da, at least 1600 Da, at least 1700 Da, at least 1800 Da, at least 1900 Da, at least 2000 Da, at least 2500 Da, at least 3000, at least 3500 Da, at least 4000 Da, at least 4500 Da or at least 5000 Da.

Several known methods can be used for fractionating the composition based on the molecular weight, such as analytical and preparative methods. Examples of appropriate methods are size exclusion chromatography (SEC), dialysis, filtration, Matrix-assisted laser desorption/ionization (MALDI) or Field Flow Fractionation (FFF), preparative SEC or continuous spin fractionation.

As a way of illustrative non-limitative examples, tangential ultrafiltration to separate two fractions (retained and permeate) can be performed.

“Permeate”, as used herein, related to the fraction of the feeding solution which crosses the membrane and contains the lower molecular weight fractions (antioxidant composition).

According to the method of the invention the product, low molecular weight (LMW) antioxidant composition, can be recovered from the permeate by any method known in the art. As a way of illustrative non-limitative example the recovery of the antioxidant product can be performed by adjusting the pH, concentration of the permeate by evaporation and extraction with organic solvent with subsequent distillation of the organic phase.

In a preferred embodiment, the pH is adjusted to about 1-4, more preferably to about 2-3. Any acidifying agent can be used for said adjustment.

“Acidifying agent” as used herein relates to any compound that can be used to reduce the pH of a composition. The acidifying agent can be selected from the group consisting of lignite, gibberellic acid, citric acid, sodium metabisulfite, malic acid, oxalic acid, succinate, acetic acid, butyric acid, valeric acid, lactic acid, pyruvic acid, malonic acid, formic acid, hydrochloric acid, nitric acid, phosphoric acid, erythronic acid, tetronic acid, sulfuric acid and fumaric acid. In a more preferred embodiment, the acidifying agent is sulfuric acid.

After pH adjustment, the permeate can be concentrated by any method known in the art, for example by evaporation. In a preferred embodiment, the removal of water is up to a volume reduction level of 12-15 times its initial volume. Next, the antioxidant composition can be extracted with an organic solvent.

“Organic solvent” as used herein relates to carbon-based substances capable of dissolving or dispersing one or more other substances. Organic solvents can be hydrocarbons, alcohols, ether and chlorinated solvents. Illustrative non-limitative examples of organic solvents are acetone, benzene, chlorobenzene, acetic acid, chloroform, 2-butanone, 1-butanol, 2-butanol, 3-pentanol, p-xylene, m-xylene, o-xylene, ethanol, ethyl acetate, ethylene glycol, formamide (DMF), pyridine, toluene, pentane, 1-propanol, nitromethane, methanol, hexane, methylene chloride, ether (MTBE), triethyl amine, N-methyl-2-pyrrolidinone (NMP), tetrahydrofuran (THF), carbon tetrachloride, cyclohexane, diethyl ether, diethylene glycol, glycerin, heptane, dimethyl sulfoxide (DMSO), acetonitrile, t-butyl alcohol dimethylether, diglyme (diethylene glycol dimethyl ether), 1,2-dimethoxy-ethane (glyme, DME), 2-propanol 1,2-dichloroethane, dioxane, hexamethylphosphorous, triamide (HMPT), hexamethylphosphoramide (HMPA). In a preferred embodiment, the organic solvent is selected from the group consisting of ethyl acetate, butanol, 3-pentanol, octanol, toluene and hexane. In a more preferred embodiment, the organic solvent is ethyl acetate. The volume ratio between the pre-evaporated permeate and the organic solvent may be 1:1, 1:2, 1:3 or 1:4.

The step of extraction, which includes the distillation of the organic solvent, will be performed at a temperature depending on the organic solvent, and it will be performed at the evaporation temperature. Said evaporation temperature depends on the pressure, therefore the temperature and the pressure can be adjusted in order to adequately evaporate the organic solvent. In the particular case of ethyl acetate, the evaporation can be performed at 75-80° C. and ambient pressure. The concentration step can be performed in a rotary evaporator.

“Depolymerisation”, as used herein relates to a process for converting the complex lignin compound into smaller molecules by cleavage of inter-unit linkages modifying the lignin propanyl side-chain and aromatic rings structure adding oxygenates to the generated fractions.

The depolymerisation which occurs during the method of the invention results in a decrease in the molecular weight of the lignin which is of about 10%, about 15%, about 20%, about 30%, about 40%, about 50%, about 60%, about 70%, about 80%, about 90% or less with respect to the molecular weight of the lignin before the method of the invention is applied. It will be understood that the term “molecular weight”, as used herein, refers to the weight average molecular weight (Mw), which describes the average that is closest to the center of the bell curve.

In some embodiments, the depolymerisation which occurs during the method of the invention when using starting material obtained from soft wood results in a decrease in the polydispersity index of the starting material which is of at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95% or more.

In some embodiments, the depolymerisation which occurs during the method of the invention when using starting material obtained from hardwood results in a decrease in the polydispersity index of the starting material which is of at least about 5%, at least about 10%, at least about 15%, at least about 20%, at least about 25%, at least about 30%, at least about 35%, at least about 40%, at least about 45% or at least about 50%.

The term “polydispersity index” is defined below in the context of the antioxidant composition of the invention and equally applicable to the method of the invention.

### Antioxidant Composition and Uses Thereof

In another aspect, the invention relates to an antioxidant composition obtained by the method of the invention.

In a preferred embodiment, the antioxidant composition of the invention shows higher antioxidant capacity compared to commercial butylated hydroxytoluene BHT, in particular about 1.5 times higher antioxidant capacity. In a more preferred embodiment, the antioxidant capacity is measured by DPPH method (RSA, Radical Scavenging Activity). In another preferred embodiment, the antioxidant composition of the invention shows 2 times higher antioxidant capacity compared to the kraft lignin. In a more preferred embodiment, the antioxidant capacity is evaluated by DPPH method (RSA, Radical Scavenging Activity).

In another preferred embodiment, the total phenolic content of the antioxidant composition of the invention is about 1 to 4 times higher, preferably about 1.5-3.5 times higher, more preferably about 2 to 3 times higher, more preferably 2 to 2.5 times higher, preferably about 2.25 times higher compared to the kraft lignin. In a more preferred embodiment, the phenolic content is evaluated by the Folin-Ciocalteau method. In another preferred embodiment, the phenolic content is evaluated by DPPH method.

In another preferred embodiment, the antioxidant composition of the invention is characterized by having an average molecular weight (Mw) of about 650-850 Da. In another preferred embodiment, the antioxidant composition of the invention is characterised by showing a polydispersity index below of 2.2. In a more preferred embodiment, the PDI is determined by HPLC-RID with NaOH 0.1 M mobile phase.

“Average molecular weight”, as used herein relates to the ordinary arithmetic mean or average of the molecular masses of the individual macromolecules. It is determined by measuring the molecular mass of n polymer molecules, adding the masses, and dividing by n.

“Polydispersity index”, PDI as used herein, relates to the ratio of weight average molecular weight (Mw) to number average (Mn) sometimes also called as molecular weight distribution. PDI is used to estimate the average uniformity of a particle solution, and larger PDI values correspond to a larger size distribution in the particle sample. PDI can be obtained by various means: GPC, Rheology solution viscosity, membrane osmosis (Van′t Hoff eq.), light scattering (Zimm plot).

The antioxidant composition of the invention contains substantially reduced nitrogen and sulphur levels with respect to the starting material.

In some embodiments, the antioxidant composition of the invention contains nitrogen levels which are at least 2-fold, at least 4-fold, at least 6-fold, at least 8-fold, at least 10-fold, at least 20-fold, at least 30-fold, at least 40-fold, at least 50-fold, at least 100-fold or less lower than those found in kraft lignin. In some embodiments, the nitrogen content in the antioxidant composition of the invention is of less than about 0.1%, 0.09%, 0.08%, 0.07%, 0.06%, 0.05%, 0.04%, 0.03%, 0.02%, 0.01%, 0.005%, 0.001% or lower (measured on a dry basis). Nitrogen content can be carried out by means of elemental analysis, which provides not only nitrogen levels but also carbon and hydrogen content.

In some embodiments, the antioxidant composition of the invention contains sulphur levels which are at least 2-fold, at least 4-fold, at least 6-fold, at least 8-fold, at least 10-fold, at least 20-fold, at least 30-fold, at least 40-fold, at least 50-fold, at least 100-fold or less lower than those found in kraft lignin. In some embodiments, the sulphur content in the antioxidant composition of the invention is of less than about 3%, 2%, 1%, 0.9%, 0.8%, 0.7%, 0.6%, 0.5%, 0.4%, 0.3%, 0.2%, 0.1%, 0.09%, 0.08%, 0.07%, 0.06%, 0.05%, 0.04%, 0.03%, 0.02%, 0.01% or lower (measured on a dry basis). Sulphur determination can be carried out according to UNE-EN 15104 and DIN/EN 15289. Therefore, the process allows to produce an antioxidant practically free of nitrogen and sulfur.

The antioxidant composition of the invention does not substantially contain vanillin (4-hydroxy-3-methoxybenzaldehyde) when the starting material is black liquor from pine wood. In another preferred embodiment when the starting material is black liquor from pine wood, the amount of vanillin is lower than 2%, more preferably 1.8%. In a more preferred embodiment, the vanillin content is determined by HPLC-MS.

In another preferred embodiment, the antioxidant composition of the invention comprises no more than 3.4% vanillin/isovanillin, preferably when the composition derives from softwood. In another preferred embodiment the antioxidant composition of the invention comprises no more than 5.5% vanillin/isovanillin, preferably when the composition derives from hardwood.

“Vanillin/isovanillin” as used herein relates to vanillin and any of its isomers, so that the value given for the abundance of vanillin/isovanillin concentration is to be understood as the sum of the concentrations of vanillin and all the different vanillin isomers, including isovanillin and any other vanillin isomer.

In another preferred embodiment, the antioxidant composition of the invention comprises less than 5.2% of methyl vanillate, more preferably about 4.3%. In another preferred embodiment, the antioxidant composition of the invention comprises less than 1% of methyl vanillate.

In another preferred embodiment, the antioxidant composition of the invention comprises phenolic OH expressed as gallic acid milliequivalents per gram of sample from 600 to 800 mGAE/g, preferably from 650 to 800 mGAE/g. In a more preferred embodiment the content of phenolic OH of the antioxidant composition expressed as gallic acid milliequivalents per gram of sample when the starting material proceed from hardwood is about 685 mGAE/g. In another preferred embodiment, the content of phenolic OH of the antioxidant composition expressed as gallic acid milliequivalents per gram of sample wherein the starting material proceed from softwood is 770 mGAE/g.

In another preferred embodiment, the antioxidant composition of the invention when derives from hardwood comprises one or more compounds selected from the group consisting of dihydroxybenzoyl)oxy-hydroxybenzoic acid, methyl vanillate, vanillic acid, decarboxyellagic acid, protocatechualdehyde, 2-Carboxysyringaldehyde 1 syringylglycoxalic acid, syringaldehyde, vanillyllactic acid, taxifolin, pyrocatechol, vanillin/isovanillin, 1-Syringoyl-1,2-dihydroxyethane, homosyringic acid, syringyl alcohol diacetate isomer 3, acetosyringone isomer 1, 5-syringovanillic acid, vanillin/isovanillin, dimethyl m-hemipinate/dimethyl isohemipate, 5-hydroxyguaiacyl-guaiacyl benzodioxane dimer and coumaryl alcohol/acetoxybenzaldehyde.

In a more preferred embodiment the antioxidant composition comprises one or more of the compounds selected from the group consisting of dihydroxybenzoyl)oxy-hydroxybenzoic acid dimer, methyl vanillate monomer, vanillic acid monomer, decarboxyellagic acid dimer, protocatechualdehyde monomer, 2-carboxysyringaldehyde/syringylglycoxalic acid monomer, syringaldehyde monomer, vanillyllactic acid monomer, taxifolin dimer, pyrocatechol monomer, vanillin/isovanillin monomer, 1-syringoyl-1,2-dihydroxyethane monomer, homosyringic acid monomer, syringyl alcohol diacetate isomer 3 monomer, acetosyringone isomer 1 monomer, 5-syringovanillic acid dimer, vanillin/isovanillin monomer, dimethyl m-hemipinate/dimethyl isohemipate monomer, 5-hydroxyguaiacyl-guaiacyl benzodioxane dimer and coumaryl alcohol/acetoxybenzaldehyde monomer.

The characterization of the antioxidant composition can be performed by any method known in the art, for example by high pressure liquid chromatography coupled to time-of-flight mass spectrometry (HPLC-ESI-QTOF-MS/MS), more particularly as described in the experimental part of the description.

In another preferred embodiment, the antioxidant composition of the invention when derives from hardwood comprises about 7 to 10% of dihydroxybenzoyl)oxy-hydroxybenzoic acid, more preferably about 8.3%, and more preferably as a dimer.

In another preferred embodiment, the antioxidant composition of the invention when derives from hardwood comprises about 6-7% more preferably 5.2% of methyl vanillate and more preferably as a monomer.

The terms “monomer”, “dimer” and “trimer” as used herein are used to define compound having one, two or three aromatic rings, respectively.

TABLE 1
List of the 20 most abundant identified phenolic compounds in the
antioxidant composition derived from hardwood (Technique: HPCL-
ESI-QTOF-MS/MS). The abundance is shown as percentage with respect
to the total content in phenolic and non-phenolic compounds.

| # | Moiety | Formula | Abundance | Name |
|---|---|---|---|---|
| 1 | Dimer | C14 H10 O7 | 8.3% | (Dihydroxybenzoyl)oxy- |
| | | | | hydroxybenzoic acid |
| 2 | Monomer | C9 H10 O4 | 5.2% | Methyl vanillate |
| 3 | Monomer | C8 H8 O4 | 4.1% | Vanillic acid |
| 4 | Monomer | C8 H8 O3 | 3.4% | Vanillin/Isovanillin |
| 5 | Dimer | C13 H8 O7 | 3.3% | Decarboxyellagic acid |
| 6 | Monomer | C7 H6 O3 | 3.0% | Protocatechualdehyde |
| 7 | Monomer | C10 H10 O6 | 3.0% | 2-Carboxysyringaldehyde/ |
| | | | | Syringylglycoxalic acid |
| 8 | Monomer | C9 H10 O4 | 2.9% | Syringaldehyde |
| 9 | Monomer | C10 H12 O5 | 2.6% | Vanillyllactic acid |
| 10 | Dimer | C15 H12 O7 | 2.5% | Taxifolin |
| 11 | Monomer | C6 H6 O2 | 2.3% | Pyrocatechol |
| 12 | Monomer | C10 H12 O4 | 2.2% | Acetosyringone |
| 13 | Monomer | C13 H16 O6 | 2.2% | Syringyl alcohol diacetate |
| 14 | Monomer | C12 H14 O6 | 2.1% | Dimethyl m-hemipinate/ |
| | | | | Dimethyl isohemipate |
| 15 | Monomer | C11 H14 O6 | 2.1% | 1-Syringoyl-1,2- |
| | | | | dihydroxyethane |
| 16 | Monomer | C10 H12 O5 | 2.0% | Homosyringic acid |
| 17 | Monomer | C9 H8 O3 | 1.5% | Coumaryl alcohol/ |
| | | | | Acetoxybenzaldehyde |
| 18 | Dimer | C17 H16 O8 | 1.4% | 5-Syringovanillic acid |
| 19 | Monomer | C10 H10 O4 | 1.4% | Coniferyl alcohol |
| 20 | Dimer | C21 H22 O8 | 1.2% | 5-Hydroxyguaiacyl- |
| | | | | guaiacyl benzodioxane |
| | | | | dimer |

In another preferred embodiment, the antioxidant composition of the invention when derived from softwood comprises one or more compounds selected from the group consisting of one or more of the compounds listed in Table 1. In some embodiments, the antioxidant composition of the invention when derived from softwood comprises one or more compounds selected from the group consisting of one or more of the compounds vanillyllactic acid, protocatechualdehyde, methyl tri-O-methylgallate, pyrocatechol, methyl tri-O-methylgallate, vanillin/isovanillin, 1,2,3-Propanetriol, 1-[4-[[2-(4-hydroxy-3-methoxyphenyl)ethenyl]oxy]-3-methoxyphenyl]/Ethanone, 1-[4-hydroxy-2-[(4-hydroxy-3,5-dimethoxyphenyl)methyl]-3,5-dimethoxyphenyl], 4-hydroxycinnamyl alcohol 4-β-D-glucoside, vanillylmandelic acid, 4-hydroxycinnamyl alcohol 4-β-D-glucoside, coumaryl alcohol/Acetoxybenzaldehyde, 1,2-Dimethyl 3,4,5-trimethoxy-1,2-benzenedicarboxylate, methyl vanillate, hydroxybenzaldehyde, 1-methoxy-1-(3,4-dimethoxyphenyl)-2-(2-methoxyphenoxy)-3-propanol-1-methoxy-1-(3,4,5-trimethoxyphenyl)-2-(2-methoxyphenoxy)-ethane, coumaryl alcohol/Acetoxybenzaldehyde ethylvanillin and 4-hydroxycinnamyl alcohol 4-β-D-glucoside.

In another preferred embodiment, the antioxidant composition of the invention when derives from softwood comprises one or more compounds selected from the group consisting of vanillyllactic acid monomer, protocatechualdehyde monomer, methyl tri-O-methylgallate, pyrocatechol monomer, vanillin/isovanillin monomer, 1,2,3-Propanetriol dimer, 1-[4-[[2-(4-hydroxy-3-methoxyphenyl)ethenyl]oxy]-3-methoxyphenyl]/Ethanone, 1-[4-hydroxy-2-[(4-hydroxy-3,5-dimethoxyphenyl)methyl]-3,5-dimethoxyphenyl] dimer, 4-hydroxycinnamyl alcohol 4-β-D-glucoside dimer, vanillylmandelic acid monomer, 4-hydroxycinnamyl alcohol 4-β-D-glucoside dimer, coumaryl alcohol/Acetoxybenzaldehyde monomer, 1,2-Dimethyl 3,4,5-trimethoxy-1,2-benzenedicarboxylate monomer, methyl vanillate, hydroxybenzaldehyde, 1-methoxy-1-(3,4-dimethoxyphenyl)-2-(2-methoxyphenoxy)-3-propanol/1-methoxy-1-(3,4,5-trimethoxyphenyl)-2-(2-methoxyphenoxy)-ethane dimer, coumaryl alcohol Acetoxybenzaldehyde monomer, ethylvanillin monomer and 4-hydroxycinnamyl alcohol 4-β-D-glucoside dimer.

In a more preferred embodiment, the antioxidant composition of the invention when derives from softwood comprises about 6 to 8% of vanillyllactic acid isomer 2, more preferably about 7.4%, more preferably as a monomer.

In another preferred embodiment, the antioxidant composition of the invention when derives from softwood comprises about 3.5. to 5% of protocatechualdehyde, more preferably about 4%, more preferably as a monomer.

In a more preferred embodiment, the amount of the compounds are determined by HPCL-ESI-QTOF-MS/MS. In one embodiment, the composition of the invention which is obtained from hardwood is characterized in that it contains the phenolic compounds shown in Table 1 wherein each compound is present at a concentration in % w/w which is at least about the abundance shown in Table 1.

TABLE 2
List of the 20 most abundant identified phenolic compounds in the
antioxidant product derived from softwood (Technique: HPCL-ESI-
QTOF-MS/MS). The abundance is shown as percentage with respect
to the total content in phenolic and non-phenolic compounds.

| # | Moiety | Formula | Abundance | Name |
|---|---|---|---|---|
| 1 | Monomer | C10 H12 O5 | 8.8% | Vanillyllactic acid |
| 2 | Monomer | C11 H14 O5 | 7.8% | Methyl tri-O-methylgallate/ |
| | | | | Methyl dimethoxymandelate |
| 3 | Monomer | C8 H8 O3 | 5.5% | Vanillin/Isovanillin |
| 4 | Monomer | C7 H6 O3 | 4.0% | Protocatechualdehyde |
| 5 | Dimer | C15 H20 O7 | 3.9% | 4-hydroxycinnamyl alcohol |
| | | | | 4-β-D-glucoside |
| 6 | Dimer | C19 H22 O7 | 3.6% | 1,2,3-Propanetriol, |
| | | | | 1-[4-[[2-(4-hydroxy-3- |
| | | | | methoxyphenyl)ethenyl]oxy]- |
| | | | | 3-methoxyphenyl]/Ethanone, |
| | | | | 1-[4-hydroxy-2- |
| | | | | [(4-hydroxy-3,5- |
| | | | | dimethoxyphenyl)methyl]-3,5- |
| | | | | dimethoxyphenyl] |
| 7 | Monomer | C6 H6 O2 | 3.2% | Pyrocatechol |
| 8 | Monomer | C12 H16 O5 | 2.8% | 1-(4-Ethoxy-3-methoxyphenyl)-2,3- |
| | | | | dihydroxy-1-propanone/Ethyl |
| | | | | β,4-dihydroxy-3- |
| | | | | methoxybenzenepropanoate |
| 9 | Monomer | C14 H18 O7 | 2.4% | 1,2-Dimethyl 4-ethoxy-3,5-dimethoxy- |
| | | | | 1,2-benzenedicarboxylate |
| 10 | Monomer | C9 H8 O3 | 2.2% | Coumaryl alcohol/Acetoxybenzaldehyde |
| 11 | Monomer | C9 H10 O5 | 1.6% | Vanillylmandelic acid |
| 12 | Monomer | C9 H10 O3 | 1.3% | Ethylvanillin |
| 13 | Monomer | C13 H16 O7 | 1.0% | 1,2-Dimethyl 3,4,5-trimethoxy-1,2- |
| | | | | benzenedicarboxylate |
| 14 | Monomer | C10 H10 O3 | 1.0% | Methyl p-coumarate |
| 15 | Monomer | C9 H10 O4 | 1.0% | Methyl vanillate |
| 16 | Monomer | C7 H6 O2 | 1.0% | Hydroxybenzaldehyde |
| 17 | Dimer | C19 H24 O6 | 0.9% | 1-methoxy-1-(3,4-dimethoxyphenyl)- |
| | | | | 2-(2-methoxyphenoxy)-3-propanol/1- |
| | | | | methoxy-1-(3,4,5-trimethoxyphenyl)- |
| | | | | 2-(2-methoxyphenoxy)-ethane |
| 18 | Monomer | C14 H18 O6 | 0.9% | 1,3-Propanediol, 2- |
| | | | | (2-methoxyphenoxy)-, |
| | | | | 1,3-diacetate/Ethyl 2-[4-(1,3- |
| | | | | dioxolan-2-yl)- |
| | | | | 2-methoxyphenoxy]acetate |
| 19 | Monomer | C19 H22 O7 | 0.8% | Ligstroside-aglycone |
| 20 | Monomer | C9 H8 O5 | 0.8% | 5-Formylvanillic acid/ |
| | | | | Vanillylglycoxalic acid |

In another preferred embodiment, the antioxidant composition of the invention when derived from hardwood comprises one or more compounds selected from the group consisting of one or more of the compounds listed in Table 2.

In a more preferred embodiment, the antioxidant composition of the invention comprises methyl vanillate as a monomer. In another preferred embodiment, the antioxidant composition of the invention comprises taxifolin as a dimer. In another preferred embodiment, the antioxidant composition of the invention comprises 5-Hydroxyguaiacyl-guaiacyl benzodioxane as a trimer.

In one embodiment, the composition of the invention which is obtained from softwood is characterized in that it contains the phenolic compounds shown in Table 2 wherein each compound is present at a concentration in % w/w which is at least about the abundance shown in Table 2.

In another preferred embodiment, the antioxidant composition of the invention obtained from hardwood comprises about 70-75%, preferably 71.9% monomer, about 35-30, preferably 27.4% dimer and about 1-2%, preferably 0.7% trimer ratio.

In another preferred embodiment, the antioxidant composition of the invention obtained from softwood is composed by 80-85%, more preferably 81.6% monomers, about 17-18%, preferably 17.3% dimers and about 1-2%, preferably 1.1% trimer ratio.

The antioxidant composition of the invention may contain one or more additional components. In some aspects, the antioxidant composition of the invention contains no additional components that materially affect the properties of the composition, in particular the antioxidant property.

The antioxidant composition obtained by the method of the invention may be utilised in any application in which inhibition of oxidation is required.

The person skilled in the art will understand that the antioxidant composition of the invention can be part of a food or feed, or of a nutraceutical, pharmaceutical composition, or cosmeceutical product or cosmetic composition which constitutes an additional aspect of the present invention. Thus, a further aspect of the present invention relates to a food, feed, pharmaceutical, cosmeceutical, cosmetic or nutraceutical product comprising the antioxidant composition of the invention. Said product can be in a liquid, semi-solid or solid form.

In a preferred embodiment, the antioxidant composition obtained by the method of the invention does not contain heavy metals. In another preferred embodiment, the antioxidant composition obtained by the method of the invention does not contain pathogenic organisms.

“Heavy metals”, as used herein relates to any metallic chemical element that has a relatively high density and is toxic or poisonous at low concentrations. Examples of heavy metals include mercury (Hg), cadmium (Cd), arsenic (As), chromium (Cr), thallium (TI), and lead (Pb).

“A pathogenic organism”, as used herein is an organism which is capable of causing diseases in a host, particularly in a human. The World Health Organization (WHO) listed among hazards that may be present in food potentially harmful bacteria, viruses, toxins and parasites.

Therefore, in an aspect the invention relates to of the antioxidant composition of the invention for use as an ingredient in a food or feed formulation. In addition, the invention relates to a food or feed comprising the antioxidant composition of the invention.

As used herein, the term “food” is any substance or product of any nature, solid or liquid, natural or processed which due to its characteristics, applications, components, preparation and state of preservation, can usually or ideally be used for some of the following purposes: a) as normal nutrition for human beings or animals or as pleasurable foods; or b) as dietetic products, in special cases of human or animal food. The term “feed” includes all the natural materials and finished products of any origin which, separately or conveniently mixed with one another, are suitable as animal food.

A ready-to-eat food is that which does not need to be diluted by means of an aqueous solution suitable for consumption for example. In principle, the ingredients present in a ready-to-eat food are balanced and there is no need to add additional ingredients to the food to make it ready to eat, such considered by a person skilled in the art. A concentrated food is that in which one or more ingredients are present at a higher concentration than in a ready-to-eat food, therefore for use it is necessary to dilute it by means of an aqueous solution suitable for consumption for example. Non-limiting, illustrative examples of foods provided by this invention include both dairy products and derivatives, for example, fermented milks, yoghurt, kephir, curd, cheeses, butters, ice creams, milk-based desserts, etc., and non-dairy products, such as baked products, cakes and pastries, cereals, chocolates, jams, juices, other fruit derivatives, oils and margarines, prepared dishes, etc.

In another particular embodiment, the product of the invention is a nutraceutical product comprising the antioxidant composition of the invention and a nutraceutical acceptable carrier. Additionally the invention relates to the use of the antioxidant composition of the invention as an ingredient in a nutraceutical product.

As used herein, the term “nutraceutical product” refers to a product suitable for use in human beings or animals, comprising one or more natural products with therapeutic action which provide a health benefit or have been associated with disease prevention or reduction, and it includes dietary supplements presented in a non-food matrix (e.g., capsules, powder, etc.) of a concentrated natural bioactive product usually present (or not) in the foods and which, when taken in a dose higher than that existing in those foods, exerts a favorable effect on health which is greater than effect which the normal food may have. Therefore, the term “nutraceutical product” includes isolated or purified food products as well as additives or food supplements which are generally presented in dosage forms normally used orally, for example, capsules, tablets, sachets, drinkable phials, etc.; such products provide a physiological benefit or protection against diseases, generally against chronic diseases. If desired, the nutraceutical product provided by the invention can contain, in addition to the antioxidant composition of the invention, one or more nutraceuticals (products or substances associated with disease prevention or reduction), for example, flavonoids, omega-3 fatty acids, etc., and/or one or more prebiotics (non-digestible food ingredients which stimulate probiotic activity and/or growth), for example, oligofructose, pectin, inulin, galacto-oligosaccharides, lactulose, human milk oligosaccharides, dietary fiber, etc.

In another particular embodiment, the product of the invention is a cosmeceutical product comprising the antioxidant composition of the invention and a cosmeceutical acceptable vehicle or carrier. Additionally, the invention relates to the use of the antioxidant composition of the invention as an ingredient in a cosmeceutical product.

As used herein, the term “cosmeceutical product” refers to a product suitable for use in the body or animal body comprising one or more cosmeceutical products (functional cosmetics, dermaceuticals or active cosmetics), i.e., topical hybrid products with cosmetic-pharmaceutical characteristics containing active ingredients having effect on user's skin, hair and/or nails, at higher and more effective concentrations, therefore they are located in an intermediate level between cosmetic and drug. Illustrative examples of cosmeceutical products include essential oils, ceramides, enzymes, minerals, peptides, vitamins, etc.

The invention relates to a cosmetic composition comprising the antioxidant composition of the invention and a cosmetic acceptable carrier or vehicle. The invention also relates to the use of the antioxidant composition of the invention for use as an ingredient in a cosmetic formulation.

“Cosmetic composition”, as used herein refers to a composition suitable for use in personal hygiene of human beings or animals, or in order to enhance the natural beauty or change the body appearance without affecting the structure or functions of the human or animal body, comprising one or more products providing such effects. If desired, the cosmetic composition provided by the invention can contain, in addition to the antioxidant composition of the invention, one or more cosmetics or cosmetic products, i.e., substances or mixtures intended to be placed in contact with the external parts of the human or animal body (e.g., epidermis, hair system, nails, lips, etc.) or with the teeth and the buccal mucosa, for the exclusive or main purpose of cleaning them, perfuming them, changing their appearance, protecting them, keeping them in good condition or correcting body odors. Illustrative examples of cosmetically acceptable vehicles include the products contained in the INCI (International Nomenclature of Cosmetic Ingredients) list. The antioxidant composition of the present invention may be added to a wide variety of products for cosmetic application, including makeup, creams for cleansing, protecting, treating, or caring for the skin, in particular, the face, hands, and feet (e.g., day and night creams, makeup removal creams, foundation creams and sunscreens), liquid foundations, makeup removal lotions, protective or skin-care body lotions, sunscreen lotions, skin care lotions, gels, or foams, such as cleansing, sunscreen, and artificial tanning lotions, bath preparations, deodorant compositions, after-shave gels or lotions, depilatory creams, and compositions used for insect stings and against pain. The antioxidant composition of the invention may take any of a wide variety of forms, and include, for example dressings, lotions, solutions, sprays, creams, gels, ointments, or the like.

In addition, the invention relates to a pharmaceutical product comprising the antioxidant composition of the invention and a vehicle or carrier suitable for oral, topical or parenteral administration. The invention also relates to the use of the antioxidant composition of the invention as an ingredient in a pharmaceutical composition.

“Pharmaceutical composition”, as used herein, relates to compositions and molecular entities that are physiologically tolerable. Preferably, the term “pharmaceutically acceptable” means it is approved by a regulatory agency of a state or federal government or is included in the U.S. Pharmacopoeia or other generally recognized pharmacopoeia for use in animals, and more particularly in humans.

The pharmaceutical acceptable carriers or vehicles are well-known to those skilled in the art and are readily available to the public.

Based on the particular mode of administration, the pharmaceutical product may be formulated into solid, liquid, injectable or topical dosage forms.

Solid dosage forms for oral administration may include conventional capsules, sustained release capsules, conventional tablets, sustained-release tablets, chewable tablets, sublingual tablets, effervescent tablets, pills, suspensions, powders, granules and gels. At these solid dosage forms, the active compounds can be mixed with at least one inert excipient such as sucrose, lactose or starch. Such dosage forms can also comprise, as in normal practice, additional substances other than inert diluents, e.g. lubricating agents such as magnesium stearate. In the case of capsules, tablets, effervescent tablets and pills, the dosage forms may also comprise buffering agents. Tablets and pills can be prepared with enteric coatings.

Liquid dosage forms for oral administration may include emulsions, solutions, suspensions, syrups and elixirs pharmaceutically acceptable containing inert diluents commonly used in the technique, such as water. Those compositions may also comprise adjuvants such as wetting agents, emulsifying and suspending agents, and sweetening agents, flavoring and perfuming agents.

Injectable preparations, for example, aqueous or oleaginous suspensions, sterile injectable may be formulated according with the technique known using suitable dispersing agents, wetting agents and/or suspending agents. Among the acceptable vehicles and solvents that can be used are water, Ringer's solution and isotonic sodium chloride solution. Sterile oils are also conventionally used as solvents or suspending media.

For topical administration the pharmaceutical composition of the invention can be formulated as creams, gels, hydrogel, lotions, liquids, pomades, spray solutions, dispersions, solid bars, emulsions, microemulsions and similars which may be formulated according to conventional methods that use suitable excipients, such as, for example, emulsifiers, surfactants, thickening agents, coloring agents and combinations of two or more thereof.

Hydrocarbon fuels, gasoline, jet fuel and fuel oil are all subject to autoxidation. Antioxidants minimize the deterioration of lubricants by retarding viscosity increase, metal corrosion, and formation of acid, sludge, resins and lacquers. Commercial organic polymers, including thermoplastics, elastomers, synthetic fibers, and adhesives, are all susceptible to oxidative degradation during both processing and end use. Therefore, the invention also relates to the use of the antioxidant composition of the invention as an ingredient in plastic, rubber, latex, fuel or lubricant formulation. The invention also relates to a plastic, rubber, latex, fuel or lubricant formulation comprising the antioxidant composition of the invention.

All the particular embodiments of the method of the present invention are also applicable to this aspect of the invention.

This invention is further illustrated by the following examples, which are not to be construed in any way as imposing limitations upon the scope thereof.

### EXAMPLES

### Materials

All reagents used are analytical grade and most of them have been supplied by SCHARLAB: NaOH, H₂SO₄, ethyl acetate, FCR, Na₂CO₃, DPPH, methanol, gallic acid, BHT and poly(styrene sulfonate) sodium salt standards. The water used is mQ grade (Milli Q Gradient; Millipore).

Gases, including N₂, O₂ and air (industrial grade) were supplied by Nippon gases.

### Example 1—Obtention of an Antioxidant Composition

The solution feed to the reactor is a mixture of kraft lignin (typically 60 g/l) and sodium hydroxide (typically 60 g/l) using deionized water as solvent.

The process of functionalization is carried by feeding the solution inside a heated and pressurized reactor built on 316 steel vessel with an internal volume of 2 L. Conditions for the reaction process are 240° C. and PT 3.8 MPa. The oxidant gas (air) is injected through a ceramic diffuser located 1 cm above the bottom of the vessel, at a flow rate of between 10 and 30 l/h and regulated by a mass flow controller. The temperature inside the reactor is regulated by an internal thermocouple linked to an external ceramic heating jacket. The total pressure inside the reactor is controlled by a backpressure valve. The residence time (10-15 min) of the feeding solution is driven by a peristaltic pump and reactor filled level control. The outlet streams (gas and liquid) are cooled in a water condenser.

After cooling to room temperature, the solution is subjected to a fractionation treatment by tangential cross filtration. The feeding solution is pumped to a membrane module where a membrane built in PES material with 3.000 Da cut-off size is placed. The solution is pumped at least at 0.5 MPa pressure and up to 1.5 MPa at a flow rate to ensure a minimum cross flow velocity of at least 0.1 m/s. The feeding is split at the membrane module in two streams. The permeate is the fraction of the feeding solution which cross the membrane and contains the lower molecular weight fractions of functionalized kraft lignin, namely product (antioxidants). The other fraction, retentate, is recirculated continuously to the feeding tank of the membrane module up to volumetric concentration factor up to 5-8 times. The final retentate is enriched in high molecular weight fractions while all the permeate is recovered for the down-processing.

The permeate is subjected to pH adjustment with sulfuric acid 2 M to pH 2-5. The next step is a liquid-liquid extraction with ethyl acetate as an organic solvent. The extraction is carried out in a two stages, counter current flow columns (0.25 L) packed with glass spheres at flow rates between 50-250 mL/min. Finally, the organic phase is subjected to distillation to recover the organic solvent. For this, a rotary evaporator (R-300; Buchi) is used, working at temperatures 75-80° C. and ambient pressure. Distillation temperature can be reduced applying vacuum under N₂ or even air atmosphere. The solid free from organic solvent is characterized.

### Example 2—Effect of Reaction Temperature in the Yield of Functionalized Lignin

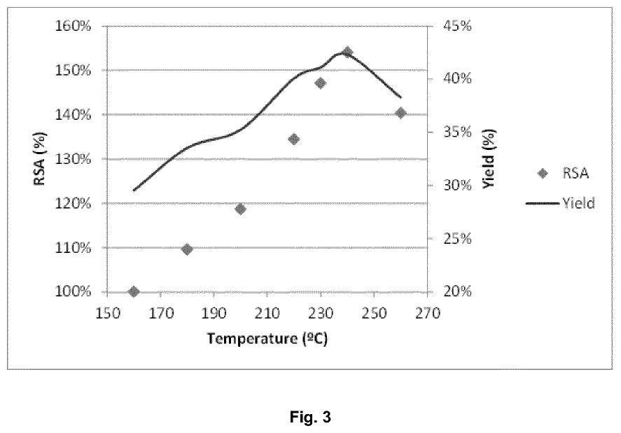

The effects of reaction temperature at a residence time not exceeding about 10 minutes on radical scavenging activity (%) measured by DPPH and on the product yield (%) calculated over lignin load were studied. Both the yield and antioxidant activity of the product increased as the reaction temperature increased as shown in FIG. 3.

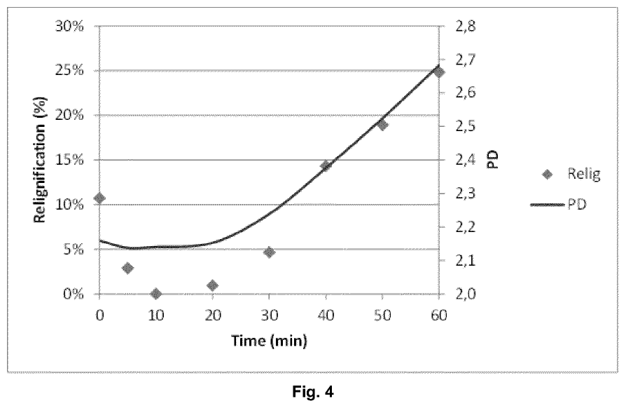

The effects of reaction time at 240° C. reaction temperature on relignification (%) and polydispersity ((PD): Mw/Mn) are shown in FIG. 4. Re-lignification (%) is the recombination or formation of lignin fractions with molecular weights higher than 2.500 Da calculated in terms of percentage variation over optimal value (t=10 min). Both relignification and polydispersity index increase as a function of the residence time, being said effect evident by residence times above 30 min.

### Example 3—Characterization of the Antioxidant Composition

The physico-chemical characterization of the product obtained is based on several analytical techniques, such as total organic content, ash content, molecular size and chemical analysis. The product yield is determined by mass balance based on initial kraft lignin load in the feeding solution to the reactor and on each step along the procedure volume fractionation streams characteristics are measured as follows:
Total solids (dry matter) are measured are determined by drying at 105° C. in a laboratory oven (ED-115; Binder) till constant weight.
In the same way inorganic solids (ash content) is determined by calcination at 850° C. for 5 hours in a muffle (BWF 11/13; Carbolite) placed on a ceramic crucible.
The organic matter (functionalized kraft lignin) content is calculated by difference of the above mentioned parameters.
The molecular size distribution of the soluble solids and its polydispersity is determined by size exclusion chromatography (HP-SEC) (1260 Infinity II; Agilent Technologies). Samples are diluted in 0.1 M NaOH and analyzed by HPLC with a Refractive Index Detector (RID) equipped with 2 PSS MCX GP-SEC columns (Molar mass range: 100-70 000 Da; dimensions 5 μm 1000 Å). The calibration is set with eight poly(styrene sulfonate) sodium salt standards in the range of 246 Da to 14.900 Da.
Chemical structure, identification of the compounds of the antioxidant composition and ratio of mono, dimer and trimers is characterized by high pressure liquid chromatography coupled to time-of-flight mass spectrometry (HPLC-ESI-QTOF-MS/MS) (Agilent 1260 HPLC with 4.6×150 mm Agilent Zorbax Eclipse Plus C18 column, particle size 1.8 μm; Agilent 650 UHD Accurate Mass Q-TOF, ESI Jet Dual Stream interphase). Samples are dissolved in methanol (10 mg/mL) and mobile phases were 0.1% formic acid in water and acetonitrile. Other parameters used are: capillary voltage 4000V, nebulizer pressure 20 psig, fragmenter voltage 130V, nozzle voltage 500V, skimmer voltage 45V and octupole voltage 750V.

The characterization of the antioxidant properties of the generated products is carried out by two spectrophotometric methods; the total phenolic content (TPC) (El Rayess et al., 2014 Wine: Phenolic Composition, Classification and Health Benefits (pp. 71-102) Chapter: 3 pp 71-102) and the DPPH free radical inhibition capacity (Brand-Williams et al., 1995 Food Science and Technology, 28 (1), 25-30; Dizhbite et al., 2004 Bioresource Technology, 95 (3), 309-317). Both are spectrophotometric methods widely used in the scientific literature regarding both lignin derivatives and antioxidants.
The TPC method measures the amount of phenolic groups in the sample based on their reaction with a Mo/W compound, called the Folin-Ciocalteau reagent (FCR). Briefly, FCR and 7.5% and Na₂CO₃ solution are added to the sample and after one hour in darkness, the absorbance of the sample is measured at 765 nm using a spectrophotometer (Genesys 10UV, Thermo Spectronic). The value is correlated with the content of phenolic groups according to a standard (gallic acid, for example).
The DPPH method measures the ability to inhibit model free radicals of a sample based on the color variations. The sample is diluted in methanol and 1 mL of a 0.16 mM solution of DPPH in methanol is added. After 2 hours its absorbance at 517 nm is measured using a spectrophotometer (Genesys 10UV, Thermo Spectronic). The result is expressed as the value of ARP, or mM of DPPH neutralized per mg of sample, and is compared with that of other commercial antioxidants: BHT (E-321, CAS 128-37-0), TBHQ (E-319, CAS 1948-33-0), Irganox 1010 (CAS 6683-19-8), α-Tocopherol (E-307, CAS 59-02-9) and rosemary extract (E-392, CAS 84604-14-8).

The antioxidant composition obtained with the method of the invention is characterized by:
Antioxidant activity is 1.5 times higher compared to a commercial BHT (synthetic antioxidant) and 2 times higher compared to the kraft lignin evaluated by DPPH method (RSA, Radical Scavenging Activity).
The antioxidant activity of the composition is also significantly higher than other natural antioxidants such as tocopherol or rosemary extract.
Total Phenolic content 2.25 times higher compared to the kraft lignin evaluated by the Folin-Ciocalteau method.
Mw and PD: 715 Da and 2 measured by HPLC-RID with NaOH 0.1 M mobile phase.

### Example 4—Further Characterization of the Antioxidant Composition

Identification of compounds by High-performance liquid chromatography coupled to electrospray ionisation and quadrupole time-of-flight mass spectrometry (HPLC-ESI-QTOF-MS) was performed. The identified compounds, many of which have known antioxidant effects, can be classified in monomer, dimer and trimer molecules based on their number of aromatic rings. The product obtained from hardwood comprises a 71.9% monomer, 27.4% dimer and 0.7% trimer ratio, whereas the product obtained from softwood is composed by a 81.6% monomer, 17.3% dimer and 1.1% trimer ratio.

Based on identification of mono, di and trimer moieties, the mass distribution of the product was determined as shown on Tables 1 and 2 depending on the lignin's wood origin (hard or soft), and a mean molar mass was assigned to each moiety. The presence of phenolic OH in the samples was determined by TPC method and expressed as gallic acid milliequivalents per gram of sample, resulting on 685 mGAE/g and 770 mGAE/g for HW (hardwood) and SW (softwood).

1- A method for producing an antioxidant composition from lignin, lignin liquor or black liquor which comprises contacting the lignin, lignin liquor or black liquor with an oxidizing agent, wherein said contacting is carried out in alkaline conditions and at a temperature above 160° C., wherein when the oxidizing agent is oxygen, a gas mixture comprising oxygen or an oxygen-generating compound or composition, then the agent is added so that the oxygen partial pressure is below 0.3 MPa.

2- The method according to claim 1, wherein the residence time is below 15 minutes.

3- The method according to claim 1, wherein the starting material is kraft lignin.

4- The method according to claim 2, wherein the starting material is kraft lignin.

5- The method according to claim 1, wherein the oxidizing agent is selected from the group consisting of oxygen, a gas mixture comprising oxygen or an oxygen-generating compound or composition.

6- The method according to claim 5, wherein the a gas mixture comprising oxygen is air and/or wherein the oxygen-generating compound or composition is selected from the group consisting of ozone, hydrogen peroxide, deionized water, O₂ plasma and alcohols.

7- The method according to claim 6, wherein air is used as gas-mixture containing oxygen.

8- The method according to claim 1, wherein the alkaline conditions are achieved by an Arrhenius base selected from the group consisting of sodium hydroxide and sodium carbonate.

9- The method according to claim 8, wherein the Arrhenius base is sodium hydroxide.

10- The method according to claim 9, wherein the sodium hydroxide is in a concentration of 2-80 g/l.

11- The method according to claim 1, wherein the temperature is between 160-260° C.

12- The method according to claim 1, wherein the total pressure is 2-5.5 MPa.

13- The method according to claim 1, wherein the pH is above 10.

14- The method according to claim 1, wherein the starting material is kraft lignin in a concentration of 7-100 g/l.

15- The method according to claim 1, further comprising a step of fractionating the composition based on the molecular weight of the compounds forming part of the composition.

16- The method according to claim 15, wherein the molecular weight cutoff of the fractionation is of at least 1000 Da.

17- The method according to claim 15, further comprising a step of purifying one or more antioxidant products from the low molecular weight fraction obtained after the size fractionation.

18- An antioxidant composition obtained by the process according to claim 1.

19- The antioxidant composition according to claim 18, characterized by having a molecular weight (Mw) of about 650-850 Da and/or a polydispersity index below of 2.2.

20- (canceled)

21- A cosmetic, pharmaceutical, plastic, rubber, latex, fuel, lubricant, food or feed formulation comprising the antioxidant composition according to claim 18.
